(19) United States
(12) Patent Application Publication
(10) Pub. No.: US 2012/0161896 A1
(43) Pub. Date: Jun. 28, 2012

(54) FREQUENCY TUNABLE BALUN CIRCUIT

(75) Inventors: Donghwan LEE, Suwon-si (KR); Heesoo YOON, Suwon-si (KR); Yoondong KIM, Yongin-si (KR); Subong JANG, Anyang-si (KR); Kyoungho LEE, Yongin-si (KR)

(73) Assignee: SAMSUNG ELECTRO-MECHANICS CO., LTD., Suwon (KR)

(21) Appl. No.: 13/185,663

(22) Filed: Jul. 19, 2011

(30) Foreign Application Priority Data
Dec. 24, 2010 (KR) 10-2010-0134695

(51) Int. Cl. H01P 5/10

(52) U.S. Cl. 333/26

(57) ABSTRACT

Disclosed herein is a frequency tunable balun circuit including: first and second balanced terminals having balanced signals outputted therefrom or inputted thereto, the balanced signals having the same magnitude and a predetermined phase difference; a first transmission line maintaining a predetermined phase difference between the first and second balanced terminals; a first inductor connected in series between the first transmission line and an unbalanced terminal having an unbalanced signal inputted thereto or outputted therefrom; a first tunable capacitive device connected in series between the unbalanced terminal and the second balanced terminal; a second transmission line connected between the first inductor and the first varacter diode; and a second tunable capacitive device connected in parallel with the second transmission line. The frequency tunable balun circuit may easily tune an operating frequency, while improving impedance matching characteristics, signal transmission loss characteristics, and signal isolation characteristics.

### CROSS REFERENCE(S) TO RELATED APPLICATIONS

This application claims the benefit under 35 U.S.C. Section 119 of Korean Patent Application Serial No. 10-2010-0134695, entitled “Frequency Tunable Balun Circuit” filed on Dec. 24, 2010, which is hereby incorporated by reference in its entirety into this application.

### BACKGROUND OF THE INVENTION

1. Technical Field

The present invention relates to a frequency tunable balun circuit, and more particularly, to a frequency tunable balun circuit capable of converting an unbalanced signal (a balanced signal) into a balanced signal (an unbalanced signal) and tuning an operating frequency.

2. Description of the Related Art

Generally, a balun, which is an acronym of a balance to unbalance transformer, indicates a device or a circuit converting a balanced signal into an unbalanced signal or converting the unbalanced signal into the balanced signal.

FIG. 1 is a diagram showing a configuration of a balun circuit according to the related art.

As shown in FIG. 1, the balun circuit includes a first inductor 14 and a plurality of second capacitors 15a and 15b formed between an input terminal 11 and a first output terminal 12 to serve as a low pass filter using a center frequency of the balun circuit as a cut-off frequency, and includes a first capacitor 16 and a plurality of second inductors 17a and 17b formed between the input terminal 11 and a second output terminal 13 to serve as a high pass filter.

However, when the balun circuit is implemented as described above, signal transmission loss characteristics between the input terminal and the first and second output terminals, return loss characteristics of an unbalanced terminal, and signal isolation characteristics of two balanced terminals have been deteriorated.

### SUMMARY OF THE INVENTION

An object of the present invention is to provide a frequency tunable balun circuit capable of easily tuning an operating frequency, while improving impedance matching characteristics, signal transmission loss characteristics, and signal isolation characteristics, by using a transmission line resonator.

According to an exemplary embodiment of the present invention, there is provided a frequency tunable balun circuit including: first and second balanced terminals having balanced signals outputted therefrom or inputted thereto, the balanced signals having the same magnitude and a predetermined phase difference; a first transmission line maintaining a predetermined phase difference between the first and second balanced terminals; a first inductor connected in series between the first transmission line and an unbalanced terminal having an unbalanced signal inputted thereto or outputted therefrom; a first tunable capacitive device connected in series between the unbalanced terminal and the second balanced terminal; a second transmission line connected between the first inductor and the first varacter diode; and a second tunable capacitive device connected in parallel with the second salon line.

The second transmission line may have a characteristic impedance and an electrical length, and may have an operating frequency determined according to the characteristic impedance and the electrical length.

The first and second tunable capacitive devices may control capacitance to tune the operating frequency.

The first and second tunable capacitive devices may have capacitance tuned according to a voltage applied thereto.

The first and second tunable capacitive devices may include a varacter diode.

The second tunable capacitive device may control a capacitance thereof to tune an impedance matching frequency at a point at which return loss in an input terminal, which is the unbalanced terminal, is minimal.

The first tunable capacitive device may control capacitance thereof to control the operating frequency at a point, at which curves of transmission loss characteristics to the first and second balanced terminals meet each other.

The predetermined phase difference may be 180 degrees.

The second transmission line may have one end connected between the first inductor and the first tunable capacitive device and the other end connected to a ground.

The second transmission line may have an electrical length above 0 degree to below 90 degrees according to a capacitance of the second tunable capacitive device.

The second transmission line may have one end connected between the first inductor and the first tunable capacitive device and the other end that opened.

The second transmission line may have an electrical length above 90 degrees to below 180 degrees according to a capacitance of the second tunable capacitive device.

### BRIEF DESCRIPTION OF THE DRAWINGS

FIG. 1 is a diagram showing a configuration of a balun circuit according to the related art;

FIG. 2 is a diagram showing a configuration of a frequency tunable balun circuit according to an exemplary embodiment of the present invention;

FIG. 3 is an equivalent circuit diagram of the frequency tunable balun circuit shown in FIG. 2;

FIG. 4A is a table showing capacitance of a varactor diode according to voltages applied thereto;

FIG. 4B is a graph of FIG. 4A;

FIG. 5 is a diagram showing a configuration of a frequency tunable balun circuit according to another exemplary embodiment of the present invention;

FIG. 6 is an equivalent circuit diagram of the frequency tunable balun circuit shown in FIG. 5;

FIG. 7 is a characteristic graph of a frequency tunable balun circuit according to a first exemplary embodiment of the present invention;

FIG. 8 is a characteristic graph of a frequency tunable balun circuit according to a second exemplary embodiment of the present invention;

FIG. 9 is a characteristic graph of a frequency tunable balun circuit according to a third exemplary embodiment of the present invention;

FIG. 10 is a characteristic graph of a frequency tunable balun circuit according to a fourth exemplary embodiment of the present invention;

FIG. 11 is a characteristic graph of a frequency tunable balun circuit according to a fifth exemplary embodiment of the present invention;

FIG. 12 is a characteristic graph of a frequency tunable balun circuit according to a sixth exemplary embodiment of the present invention; and

FIG. 13 is a characteristic graph of a frequency tunable balun circuit according to a seventh exemplary embodiment of the present invention.

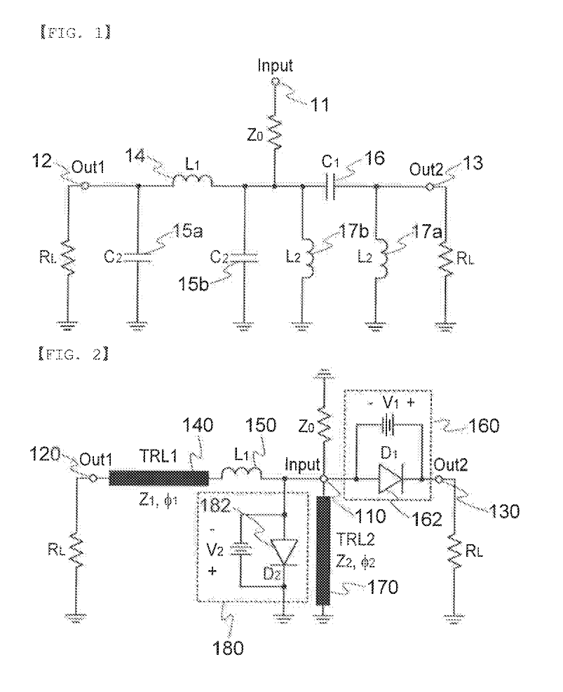

### DESCRIPTION OF THE PREFERRED EMBODIMENTS

The terms and words used in the present specification and claims should not be interpreted as being limited to typical meanings or dictionary definitions, but should be interpreted as having meanings and concepts relevant to the technical scope of the present invention based on the rule according to which an inventor can appropriately define the concept of the term to describe most appropriately the best method he or she knows for carrying out the invention.

Therefore, the configurations described in the embodiments and drawings of the present invention are merely most preferable embodiments but do not represent all of the technical spirit of the present invention. Thus, the present invention should be construed as including all the changes, equivalents, and substitutions included in the spirit and scope of the present invention at the time of filing this application.

Hereinafter, exemplary embodiments of the present invention will be described in detail with reference to the accompanying drawings.

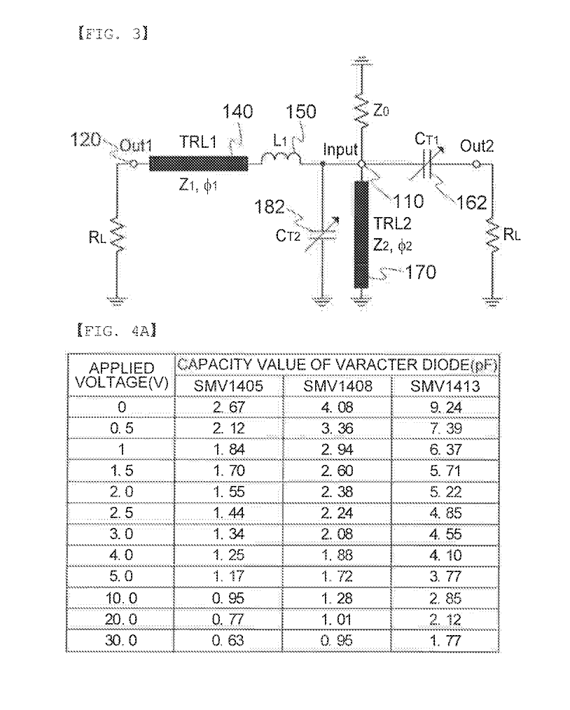

FIG. 2 is a diagram showing a configuration of a frequency tunable balun circuit according to an exemplary embodiment of the present invention; and FIG. 3 is an equivalent circuit diagram of the frequency tunable balun circuit shown in FIG. 2.

As shown in FIGS. 2 and 3, a frequency tunable balun circuit 100 is configured to include an unbalanced terminal 110, first and second balanced terminals 120 and 130, a first transmission line 140, a first inductor 150, a first tunable capacitive device 160, a second transmission line 170, and a second tunable capacitive device 180.

The unbalanced terminal 110, which is a unit to/from which an unbalanced signal is inputted or outputted, may be an input terminal Input according to an exemplary embodiment of the present invention.

The first and second balanced terminals 220 and 130, which are units from/to which first and second balanced signals having the same magnitude and a phase difference of 180 degrees are outputted or inputted, may be first, and second output terminals out1 and out2, according to an exemplary embodiment of the present invention.

The first transmission line 140 is a transmission line maintaining a predetermined phase difference between the first and second balanced terminals 120 and 130, wherein the predetermined phase difference may be preferably 180 degrees and may include 180 degrees±error.

The first transmission line 140 may be represented by a first characteristic impedance Z₁ and a first electrical length φ₁, which may be tuned according to characteristics of the frequency tunable balun circuit 100.

The first inductor 150 is connected in series between the unbalanced terminal 110 and the first transmission line 140 to configure the frequency tunable balun circuit 100.

The first tunable capacitive device 160, which is a unit having a capacity value tuned according to a voltage V1 applied thereto, is connected in series between the unbalanced terminal 110 and the second balanced terminal 130.

In addition, the first tunable capacitive device 160 may include a first varacter diode 162, which may have a capacitive value tuned in inversely proportional to a reverse voltage applied thereto.

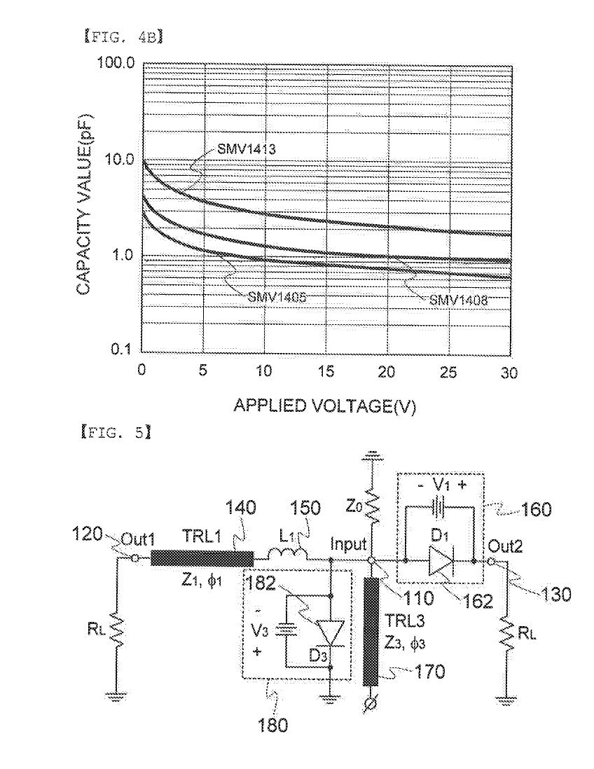

FIG. 4A is a table showing capacitance of a varactor diode according to voltages applied thereto; and FIG. 4B is a graph of FIG. 4A. Referring to FIGS. 4A and 4B, applied voltage V indicates a reverse bias voltage applied to the varacter diode, and SMV1405, SMV1408, and SMV1413 indicate kinds of varacter diodes.

As shown in table of FIG. 4A and graph of FIG. 4B, it may be appreciated that capacitance of the varacter diode may be tuned according to the reverse bias voltage applied thereto.

In addition, it may be appreciated that a tuned degree of the capacity value is changed according to the kind of varacter diode.

Therefore, the first varacter diode 162 included in the first tunable capacitive device 160 controls the capacitance thereof according to the reverse bias voltage applied thereto to control an operating frequency at a point at which curves of transmission loss characteristics to the first and second balanced terminals 120 and 130 meet each other.

The second transmission line 170 has one end connected between the first inductor 150 and the first tunable capacitive device 160 and the other end connected to a ground. The second transmission line 170 may be represented by a second characteristic impedance Z₂ and a second electrical length φ₂, which may be toned according to the characteristics of the frequency tunable balun circuit 100.

In addition, the second electrical length φ₂ of the second transmission line 170 may be above 0 degree to below 90 degrees according to a capacitance of the second tunable capacitive device 180.

Further, the above-mentioned transmission line is substituted for a resonator circuit configured of an inductor L and a capacitor C to perform a resonant operation.

The second tunable capacitive device 180, which is a unit having a capacitance tuned according to a voltage V₂ applied thereto, is connected in parallel with the second transmission line 170.

In addition, the second tunable capacitive device 180 may include a second varacter diode 182, which may have a capacitance tuned in inversely proportional to a reverse bias voltage applied thereto.

Therefore, the second tunable capacitive device 180 may control the capacitance thereof according to the reverse bias voltage applied thereto to tune the second electrical length φ₂ and an operating frequency of the second transmission line 170. More specifically, the second tunable capacitive device 180 may control the capacitance thereof to tune an impedance matching frequency at a point at which return loss in the input terminal is minimal, which is the unbalanced terminal. Here, the impedance matching frequency may be formed of a maximal impedance matching frequency.

Meanwhile, a resistor Z₀ connected to the input terminal, which is the unbalanced terminal 110, indicates a characteristic impedance of the input terminal Input to which the unbalanced signal is inputted, and resistors R_{L} each connected to the first and second output terminals out1 and out2, which are the first and second balanced terminals 120 and 130, indicate load impedances of the first, and second output terminals out1 and out 2 from which the first and second balanced signals are outputted.

In addition, the input terminal Input and the first and second output terminals out1 and out2 may be interchanged according to a direction of a signal introduced thereinto.

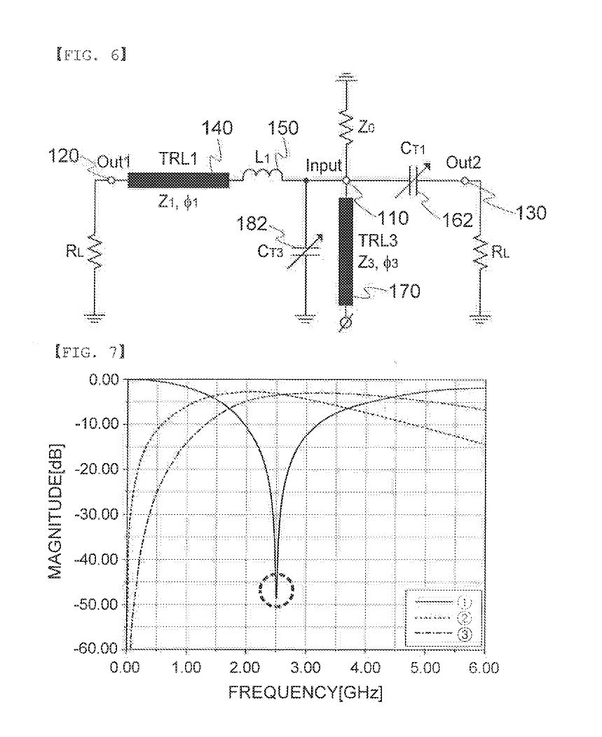

FIG. 5 is a diagram showing a configuration of a frequency tunable balun circuit according to an exemplary embodiment of the present invention; and FIG. 6 is an equivalent circuit diagram of the frequency tunable balun circuit shown in FIG. 5.

As shown in FIGS. 5 and 6, a frequency tunable balun circuit 100 is configured to include an unbalanced terminal 110, first and second balanced terminals 120 and 130, a first transmission line 140, a first inductor 150, a first tunable capacitive device 160, second transmission line 170, and a second tunable capacity device 180.

Hereinafter, a description of a configuration having the same function as that described in the first exemplary embodiment will be omitted.

The second transmission line 170 has one end connected between the first inductor 150 and the first tunable capacitive device 160 and the other end that is opened. The second transmission line 170 may be represented by a second characteristic impedance Z₂ and a second electrical length φ₂, which may be tuned according to the characteristics of the frequency tunable balun circuit 100.

In addition, since the other end of the second transmission line 170 is opened, the second electrical length φ₂ of the second transmission line 170 may be above 90 degrees to below 180 degrees according to a capacitance of the second varacter diode 192 included in the second tunable capacitive device 130.

Hereinafter, characteristics of a frequency tunable balun circuit according to first and seventh exemplary embodiments of the present invention will be described.

FIGS. 7 to 13 are characteristic graphs of a frequency tunable balun circuit according to first and seventh exemplary embodiments of the present invention.

First, FIG. 7 snows the characteristic of the frequency tunable balun circuit in the case in which a center frequency was set to 2.5 GHz, an input impedance Z₀ was set to 50Ω, an output impedance R_{L} was set to 50Ω, an inductance of a first inductor was set to 3.183 nH, a capacitance of a first varacter diode 162 was set to 1.25 pF, and a capacitance of a second varacter diode 182 was set to 1.25 pF.

In addition, a first characteristic impedance Z₁ of a first transmission line 140 was set to 50Ω, a first electrical length φ₁ of a first transmission line 140 was set to 90 degrees, a second characteristic impedance Z₂ of a second transmission line 170 was set to 39Ω, and a second electrical length φ₂ of a second transmission line 170 was set to 52 degrees.

Further, a first curve \textcircled{1} indicates return loss in an input terminal Input, a second curve \textcircled{2} indicates transmission loss characteristics from the input terminal to a first output terminal out1, and a third curve \textcircled{3} indicates transmission loss characteristics from the input terminal to a second output terminal out2.

It may be appreciated from the characteristic graph of FIG. 7 that an operating frequency of the frequency tunable balun circuit is 2.5 GHz under the above-mentioned setting condition.

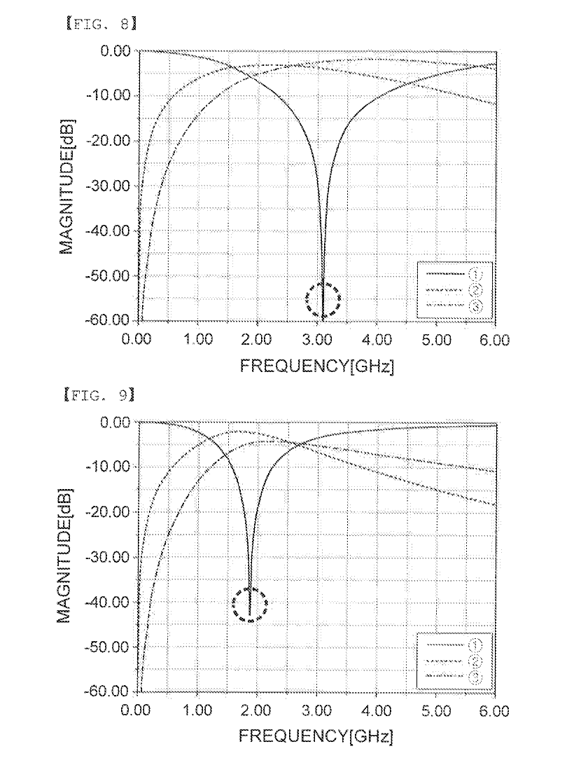

FIG. 8 shows the characteristic of the frequency tunable balun circuit in the case in which the capacitance of the first varacter diode 162 was fixed to 1.25 pF as in FIG. 7, and the capacitance of the second varacter diode 182 was changed to 0.63 pF, under the same setting condition as that of FIG. 7.

When the capacitance of the first varacter diode 162 was fixed and the capacitance of the second varacter diode 182 was reduced as described above, it may be appreciated that an operating frequency of the frequency tunable balun circuit increases from 2.5 GHz to 3.1 GHz.

FIG. 9 shows the characteristic of the frequency tunable balun circuit in the case in which the capacitance of the first varacter diode 162 was fixed to 1.25 pF as in FIG. 7, and the capacitance of the second varacter diode 182 was changed to 2.67 pF, under the same setting condition as that of FIG. 7.

When the capacitance of the first varacter diode 162 was fixed and the capacitance or the second varacter diode 182 was increased as described above, it may be appreciated that an operating frequency of the frequency tunable balun circuit decreases from 2.5 GHz to 1.9 GHz.

When the capacitance of the first varacter diode 162 was fixed and the capacitance of the second varacter diode 132 was controlled as described above, a maximal impedance matching frequency at a point at which return loss in the input terminal is minimal may be tuned.

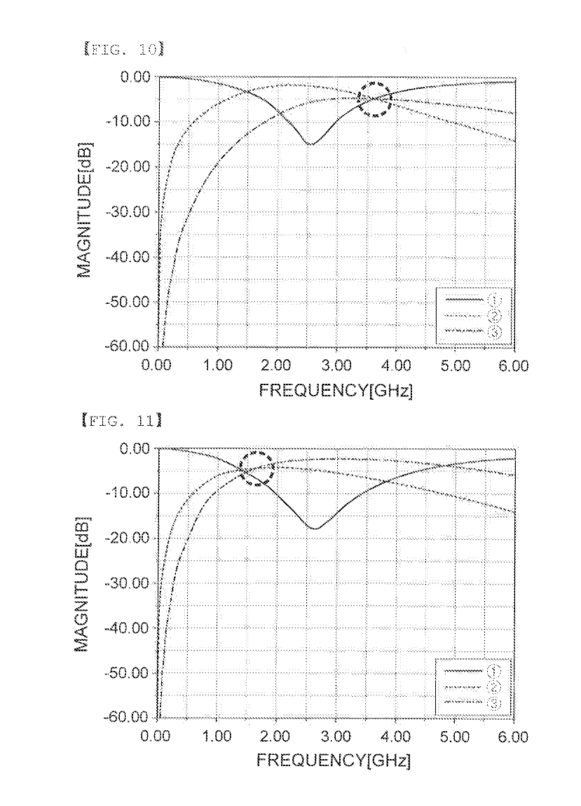

FIG. 10 shows the characteristic of the frequency tunable balun circuit in the case in which the capacitance of the second varacter diode 182 was fixed to 1.25 pF, and the capacitance of the first varacter diode 162 was changed to 0.63 pF, under the same setting condition as that of FIG. 7.

When the capacitance of the second varacter diode 182 was fixed and the capacitance of the first varacter diode 162 was reduced as described above, it may be appreciated that a frequency at which a second curve \textcircled{2} and a third curve \textcircled{3}, which are the transmission loss characteristics to two balanced terminals, meet each other may be tuned. That is, it may be appreciated that the frequency at which the second curve \textcircled{2} and the third curve \textcircled{3}, which are the transmission loss characteristics to the two balanced terminals, meet each other increases from 2.5 GHz to 3.6 GHz in FIG. 10.

FIG. 11 shows the characteristic of the frequency tunable balun circuit in the case in which the capacitance of the second varacter diode 182 was fixed to 1.25 pF, and the capacitance of the first varacter diode 162 was changed to 2.67 pF, under the same setting condition as that of FIG. 7.

When the capacitance of the second varacter diode 162 was fixed and the capacitance of the first varacter diode 162 was increased as described above, it may be appreciated that the frequency at which a second curve \textcircled{2} and a third curve \textcircled{3}, which are the transmission loss characteristics to the two balanced terminals, meet each other decreases from 2.5 GHz to 1.6 GHz.

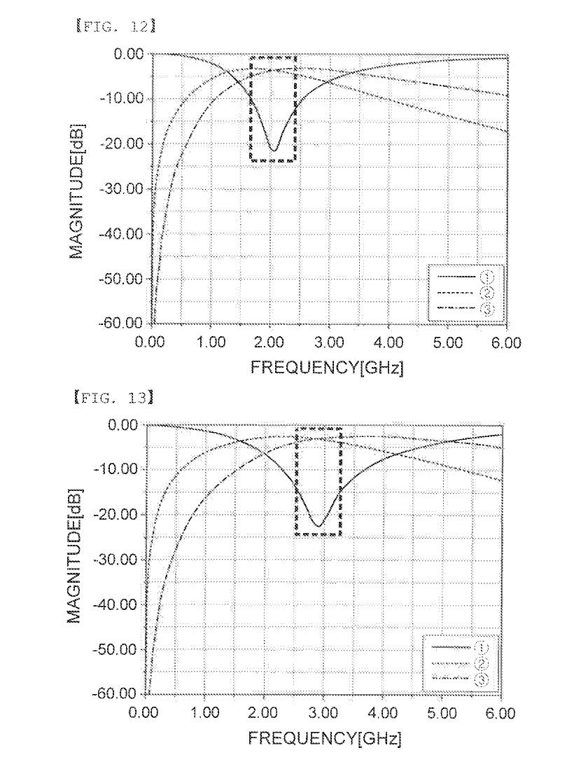

FIG. 12 shows the characteristics of the frequency tunable balun circuit in the case in which the capacitance of the first varacter diode 162 was set to 1.84 pF and the capacitance of the second varacter diode 182 was set to 2.12 pF, under the same setting condition as that of FIG. 7, and FIG. 13 shows the characteristics of the frequency tunable balun circuit in the case in which the capacitance of the first varacter diode 162 was set to 0.95 pF and the capacitance off the second varacter diode 182 was set to 0.77 pF, under the same setting condition as that of FIG. 7.

It may be appreciated from FIGS. 12 and 13 that an operating frequency of a frequency tunable balun circuit and a frequency at which a second curve \textcircled{2} and a third curve \textcircled{3} meet each other decreases from 2.5 GHz to 2 GHz in FIG. 12, and an operating frequency of a frequency tunable balun circuit and a frequency at which a second curve \textcircled{2} and a third curve \textcircled{3} meet each other increases from 2.5 GHz to 2.9 GHz in FIG. 13.

As a result, it may be appreciated that the capacitance of the first varacter diode 162 controls a magnitude of the operating frequency at which the second curve \textcircled{2} and the third curve \textcircled{3}, which are the transmission loss characteristics to the two balanced terminals, meet each other, and the capacitance of the second varacter diode 182 determines the maximal impedance matching frequency at a point at which a magnitude of the first curve \textcircled{1} is minimal, that is, a point at which an input reflection coefficient is minimal, according to the characteristics of the frequency tunable balun circuit shown in FIGS. 7 to 13. That is, the reverse bias voltage applied to the first and second varacter diodes 162 and 182 is controlled, thereby making it possible to freely control the operating frequency.

As described above, with the frequency tunable balun circuit according to the exemplary embodiment of the present invention, the transmission line resonator is used, thereby making it possible to improve the impedance matching characteristics, the signal transmission loss characteristics, and the signal isolation characteristics.

In addition, the tunable capacitive device is used, thereby making it possible to easily tune an operating frequency.

That is, the balun circuit that has been implemented in a stacked chip form, etc., using an existing ceramic is manufactured to be easily implemented in a radio frequency integrated circuit (RFIC), a monolithic microwave integrated circuit (MMIC), a radio frequency micro electro mechanical system (RF-MEMS), or the like, thereby making it possible to easily control the operating frequency, simultaneously with being integrated in the integrated circuit.

Although the exemplary embodiments of the present invention have been shown and described, the present invention is not limited thereto but various changes and modifications may be made by those skilled in the art without departing from the spirit of the invention.

What is claimed is:

1. A frequency tunable balun circuit comprising:
first and second balanced terminals having balanced signals outputted therefrom or inputted thereto, the balanced signals having the same magnitude and a predetermined phase difference;
a first transmission line maintaining a predetermined phase difference between the first and second balanced terminals;
a first inductor connected in series between the first transmission line and an unbalanced terminal having an unbalanced signal inputted thereto or outputted therefrom;
a first tunable capacitive device connected in series between the unbalanced terminal and the second balanced terminal;
a second transmission line connected between the first inductor and the first varacter diode; and
a second tunable capacitive device connected in parallel with the second transmission line.

2. The frequency tunable balun circuit, according to claim 1, wherein the second transmission line has a characteristic impedance and an electrical length and
has an operating frequency determined according to the characteristic impedance and the electrical length.

3. The frequency tunable balun circuit according to claim 2, wherein the first and second tunable capacitive devices control capacitance to tune the operating frequency.

4. The frequency tunable balun circuit according to claim 3, wherein the first and second tunable capacitive devices have capacitance tuned according to a voltage applied thereto.

5. The frequency tunable balun circuit according to claim 1, wherein the first and second tunable capacitive devices include a varacter diode.

6. The frequency tunable balun circuit according to claim 2, wherein the second tunable capacitive device controls a capacitance thereof to tune an impedance matching frequency at a point at which return loss in an input terminal, which is the unbalanced terminal, is minimal.

7. The frequency tunable balun circuit according to claim 2, wherein the first tunable capacitive device controls capacitance thereof to control the operating frequency at a point at which curves of transmission loss characteristics to the first and second balanced terminals meet each other.

8. The frequency tunable balun circuit according to claim 1, wherein the predetermined phase difference is 180 degrees.

9. The frequency tunable balun circuit according to claim 2, wherein the second transmission line has one end connected between the first inductor and the first tunable capacitive device and the other end connected to a ground.

10. The frequency tunable balun circuit according to claim 9, wherein the second transmission line has an electrical length above 0 degree to below 90 degrees according to a capacitance of the second tunable capacitive device.

11. The frequency tunable balun circuit according to claim 2, wherein the second transmission line has one end connected between the first inductor and the first tunable capacitive device and the other end that is opened.

12. The frequency tunable balun circuit according to claim 11, wherein the second transmission line has an electrical length above 90 degrees to below 100 degrees according to a capacitance of the second tunable capacitive device.
